(19) United States
(12) Patent Application Publication
(10) Pub. No.: US 2020/0098021 A1
(43) Pub. Date: Mar. 26, 2020

(54) PUBLIC SERVICE MOBILE BODY UTILIZATION SUPPORT SYSTEM AND PUBLIC SERVICE MOBILE BODY UTILIZATION SUPPORT METHOD

(71) Applicant: HONDA MOTOR CO., LTD., Tokyo (JP)

(72) Inventors: Kei Nakajima, Tokyo (JP); Hirotaka Uchitomi, Tokyo (JP); Kichinosuke Fukuhara, Wako-shi, Saitama (JP)

(21) Appl. No.: 16/547,124

(22) Filed: Aug. 21, 2019

(30) Foreign Application Priority Data
Sep. 20, 2018 (JP) 2018-175631

(51) Int. Cl. G06Q 30/02; G06Q 10/02; G08G 1/127; G06Q 50/30; H04W 4/40

(52) U.S. Cl. CPC G06Q 30/0284; G06Q 10/02; H04W 4/40; G06Q 50/30; G08G 1/127

(57) ABSTRACT

A desired get-on condition acquisition module acquires a desired get-on condition including a first area and a first time at which a user desires to get on a public service vehicle. A desired get-off condition acquisition module acquires a desired get-off condition including a second area and a second time at which the user desires to get off the public service vehicle. An applicable public service mobile body extraction module extracts an applicable public service vehicle based on operation information of the public service vehicle, the desired get-on condition and the desired get-off condition, the applicable public service vehicle being a public service mobile body scheduled to operate in such a manner that the user can get on the public service mobile body at the first time within the first area and can get off the public service mobile body at the second time within the second area.

### INCORPORATION BY REFERENCE

The present application claims priority under 35 U.S.C. § 119 to Japanese Patent Application No. 2018-175631 filed on Sep. 20, 2018. The content of the application is incorporated herein by reference in its entirety.

### BACKGROUND OF THE INVENTION

### Field of the Invention

The present invention relates to a public service mobile body utilization support system and a public service mobile body utilization support method.

### Description of the Related Art

Conventionally, there is known a vehicle operation system in which an operation plan for public service vehicles is determined according to demands from users of the public service vehicles that include get-on points, get-on times, and get-off points (for example, refer to Japanese Patent Laid-Open No. 2010-244177). In this vehicle operation system, reservation facilitating information on public service vehicles operating according to the determined operation plan is presented regularly to users.

### SUMMARY OF THE INVENTION

### Technical Problem

According to the vehicle operation information providing system described in Japanese Patent Laid-Open No. 2010-244177 above, a user can easily reserve his or her seat on a public service vehicle for use for movement to his or her destination by recognizing the degree of crowdedness or the like of public service vehicles through the reservation facilitating information.

In this way, although users generally utilize public service mobile bodies such as public service vehicles as a moving means to their destinations, it is also considered that users utilize public service mobile bodies as multipurpose spaces that they can utilize.

The present invention has been made in view of these situations, and an object of the present invention is to provide a public service vehicle utilization support system and a public service vehicle utilization support method that can support the use of public service mobile bodies as spaces.

### Solution to Problem

As a configuration to achieve the object, there is provided a public service mobile body utilization support system, including an operation information recognition module configured to recognize operation information of a public service mobile body, a desired get-on condition acquisition module configured to acquire a desired get-on condition including a first area and a first time at which a user desires to get on the public service mobile body, a desired get-off condition acquisition module configured to acquire a desired get-off condition including a second area and a second time at which the user desires to get off the public service mobile body, and an applicable public service mobile body extraction module configured to extract an applicable public service mobile body based on the operation information, the desired get-on condition, and the desired get-off condition, the applicable public service mobile body being the public service mobile body that is scheduled to operate in such a manner as to allow the user to get on at the first time within the first area and to get off at the second time within the second area.

In the configuration described above, there may be provided a get-on and get-off schedules informing module configured to inform the user of a get-on point and a scheduled get-on time at which the user gets on the applicable public service mobile body within the first area and a get-off point and a scheduled get-off time at which the user gets off the applicable public service mobile body within the second area.

In the configuration described above, there may be provided a user position recognition module configured to recognize a current position of the user, and the applicable public service mobile body extraction module may extract the applicable public service mobile body with which a distance between a get-on point within the first area and a current position of the user falls within a predetermined distance.

In the configuration described above, there may be provided a first utilization fare determination module configured to determine a utilization fare of the applicable public service mobile body by the user according to a get-on point within the first area.

In the configuration described above, the first utilization fare determination module may determine a utilization fare of the applicable public service mobile body by the user according to a distance between a get-on point within the first area and a current position of the user.

In the configuration described above, there may be a second utilization fare determination module configured to, when the applicable public service mobile body is enabled to be extracted by the applicable public service mobile body extraction module by changing a scheduled running route of the public service mobile body, determine a utilization fare of the applicable public service mobile body by the user according to a degree of change of the scheduled running route.

In the configuration described above, there may be provided a get-on and get-off time changeable range setting module configured to set a changeable range of the first time or the second time that the user can permit, and the applicable public service mobile body extraction module may extract the applicable public service mobile body enabling the user to get on within the changeable range for the first time or to get off within the changeable range for the second time.

In the configuration described above, there may be provided a user preference information acquisition module configured to acquire preference information of the user, and the applicable public service mobile body extraction module may extract the applicable public service mobile body based on a preference of the user that the applicable public service mobile body extraction module recognizes from the preference information.

In addition, as a configuration to achieve the object, there is provided a public service mobile body utilization support method, including: an operation information recognizing step of recognizing operation information of a public service mobile body; a desired get-on condition acquiring step of acquiring a desired get-on condition including a first area and a first time at which a user desires to get on the public service mobile body; a desired get-off condition acquiring step of acquiring a desired get-off condition including a second area and a second time at which the user desires to get off the public service mobile body; and an applicable public service mobile body extracting step of extracting an applicable public service mobile body based on the operation information, the desired get-on condition, and the desired get-off condition, the applicable public service mobile body being the public service mobile body that is scheduled to operate in such a manner as to allow the user to get on at the first time within the first area and to get off at the second time within the second area.

### Advantageous Effect of the Invention

According to the public service mobile body utilization support system and the public service mobile body utilization support method, the operation information of the public service mobile body is recognized by the operation information recognition module or the operation information recognizing step. In addition, the desired get-on condition including the information on the first area and the first time at which the user desires to get on the public service mobile body is acquired by the desired get-on condition acquisition module, and the desired get-off condition including the second area and the second time at which the user desires to get off the public service mobile body is acquired by the desired get-off condition acquisition module. Then, the applicable public service mobile body is extracted by the applicable public service mobile body extraction module based on the operation information of the public service mobile body, the desired get-on condition and the desired get-off condition of the user, the applicable public service mobile body being the public service mobile body that is scheduled to operate in such a manner as to allow the user to get on at the first time within the first area and to get off at the second time within the second area.

By getting on the applicable public service mobile body that is extracted in the way described above, the user can utilize the space within the applicable public service mobile body while moving between the desired areas within the desired time band. Thus, the utilization of the public service mobile body as a space can be supported.

### BRIEF DESCRIPTION OF THE DRAWINGS

FIG. 1 is an explanatory diagram of a support mode by a public service mobile body utilization support system;

FIG. 2 is a configuration diagram of the public service mobile body support system;

FIG. 3 is an explanatory diagram of public service vehicle operation information;

FIG. 4 is an explanatory diagram of desired get-on/get-off information;

FIG. 5 is a flow chart of a support process by the public service mobile body utilization support system; and

FIG. 6 is an explanatory diagram of a desired get-on and get-off conditions receiving screen and an applicable public service vehicle guide screen on a communication terminal of a user.

### DETAILED DESCRIPTION OF THE PREFERRED EMBODIMENTS

### [1. Support Mode of Public Service Mobile Body Utilization Support System]

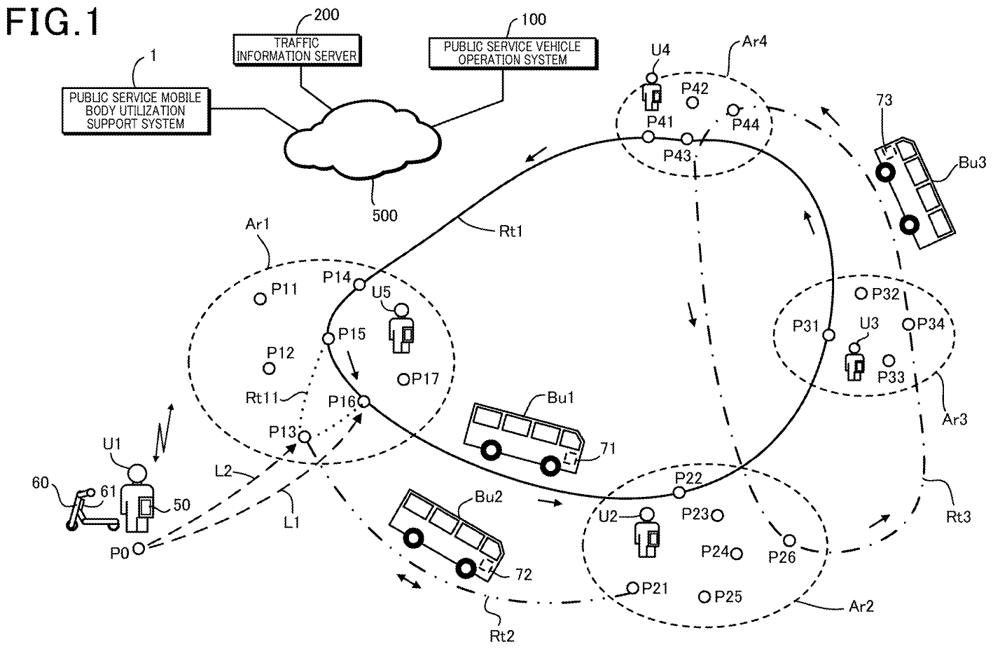

FIG. 1 illustrates a support mode by a public service mobile body utilization support system 1 of the present embodiment. In this embodiment, the public service mobile body utilization support system 1 supports the utilization of public service vehicles Bu1 to Bu3 such as buses that are public service mobile bodies by users U1 to U5.

The operation of the public service vehicles Bu1 to Bu3 is controlled by a public service vehicle operation system 100. The public service vehicle operation system 100 controls a running route and a running schedule of each of the public service vehicles Bu1 to Bu3 among four areas Ar1 to Ar4. In FIG. 1, a running route Rt1, circulating in the order of the area Ar1→Ar2→Ar3→Ar4→Ar1→ . . . , is set for the public service vehicle Bu1. Here, the areas Ar1 to Ar4 are set individually as zones defining certain extents on the periphery, for example, of a certain railway terminal station or a large shopping center.

A running route Rt2, reciprocating between the area Ar1 and the area Ar2 is set for the public service vehicle Bu2. A running route Rt3, circulating in the order of the area Ar2→Ar3→Ar4→Ar2→ . . . , is set for the public service vehicle Bu3. Bus stops, where users get on the public service vehicles and get off the public service vehicles, are provide in the individual areas Ar1 to Ar4.

Seven bus stops P11 to P17 are provided in the area Ar1. Six bus stops P21 to P26 are provided in the area Ar2. Four bus stops P31 to P33 are provided in the area Ar3. Four bus stops P41 to P44 are provided in the area Ar4.

The public service vehicle operation system 100 determines bus stops where the public service vehicles stop in the areas Ar1 to Ar4 according to desired get-on and get-off requests transmitted from communication terminals 50 carried by the users U1 to U5. For example, in FIG. 1, the public service vehicle operation system 100 sets the bus stops P14, P15, and P16 as get-on and get-off positions in the area Ar1 for the running route Rt1. It should be noted that the running routes and running schedules of the public service vehicles in the areas Ar1 to Ar4 may be determined according to desired get-on/get-off requests of the users U1 to U5.

Onboard devices 71 to 73 installed in the public service vehicles Bu1 to Bu3, respectively, each include a Global Positioning System (GPS) sensor, so that information on current positions of the public service vehicles Bu1 to Bu3 detected by the GPS sensors is transmitted to the public service vehicle operation system 100 at all times. The communication terminals 50 carried by the users U1 to U5 also each include a GPS sensor, so that the communication terminals 50 transmit information on their current positions (current positions of the users U1 to U5) detected by the GPS sensors to the public service mobile body utilization support system 1.

The public service vehicle operation system 100 recognizes running situations of the public service vehicles Bu1 to Bu3 from the information on the current positions of the public service vehicles Bu1 to Bu3 that the public service vehicle operation system 100 has received from the onboard devices 71 to 73. Additionally, the public service vehicle operation system 100 gains access to a traffic information server 200 to acquire information on traffic jams on the individual running routes Rt1 to Rt3. Then, the public service vehicle operation system 100 recognizes the respective operating situations of the public service vehicles Bu1 to Bu3 based on the respective running situations of the public service vehicles Bu1 to Bu3 and the information on the respective traffic jams on the running routes Rt1 to Rt3.

The users U1 to U5 transmits desired get-on and get-off condition including a desired get-on condition under which the users desire to get on the public service vehicles and a desired get-off condition under which the users desire to get off the public service vehicle to the public service mobile body utilization support system 1 by operating the communication terminals 50 carried by the users U1 to U5. In the following description, a case will be described in which the user U1 transmits a desired get-on and get-off condition in which the user U1 designates a movement from the area Ar1 to the area Ar2 to the public service mobile body utilization support system 1.

Here, the desired get-on condition includes the area (corresponding to a first area in the present invention) and a time (corresponding to a first time in the present invention) at which the user U1 desires to get on the public service vehicle. In addition, the desired get-off condition includes the area (corresponding to a second area in the present invention) and a time (corresponding to a second time in the present invention) at which the user U1 desires to get off the public service vehicle.

There occurs a case where the user U1 desires to get on and get off the public service vehicle in the same area and desires to get off the public service vehicle after a certain period of time has elapsed in the same area. This case is a mode wherein the user U1 does not utilize the public service vehicle as a traveling means but utilizes it as a space that the user U1 can utilize for such a certain period of time.

In this way, the user U1 makes an inquiry about whether the user U1 can utilize the public service vehicle within a desired time band by not designating a specific bus stop but designating an area having a certain extent as get-on and get-off places. Due to this, the user U1 does not have to have knowledge about running routes and running schedules of the public service mobile bodies.

When receiving a desired get-on and get-off condition transmitted from the communication terminal 50 of the user U1, the public service mobile body utilization support system 1 extracts an applicable public service vehicle (corresponding to an applicable public service mobile body in the present invention) which is a public service vehicle operated in such a manner that the user U1 can get on at a first time within a first area (here, the area Ar1) and can get off at a second time within a second area (here, the area Ar2).

Then, the public service mobile body utilization support system 1 transmits information on the applicable public service vehicle to the communication terminal 50 of the user U1. The user U1 confirms the information on the applicable public service vehicle to thereby get on the public service vehicle Bu1 at any one of the bus stops within the area Ar1. Additionally, the user U1 can get off the public service vehicle Bu1 at any one of the bus stops within the area Ar2.

In the example illustrated in FIG. 1, the user U1 carries a small mobility 60 that the user U1 is permitted to bring with him or her into the public service vehicle and moves from a current position P0 to a bus stop within the area Ar1 using the small mobility 60. The small mobility 60 is, for example, a self-propelled kick board using an electric motor as its drive source and includes a controller 61 configured to control the operation of the small mobility 60. In this case, the user U1 can include his or her desire to move to a get-on point using the small mobility 60 in the desired get-on condition. Then, when the user U1 moves to a get-on point using the small mobility 60, the public service mobile body utilization support system 1 extracts a public service vehicle that the user U1 can get on at the first time by taking into consideration the time being spent to move from the current position P0 to the get-on point using the small mobility 60.

### [2. Configuration of Public Service Mobile Body Utilization Support System]

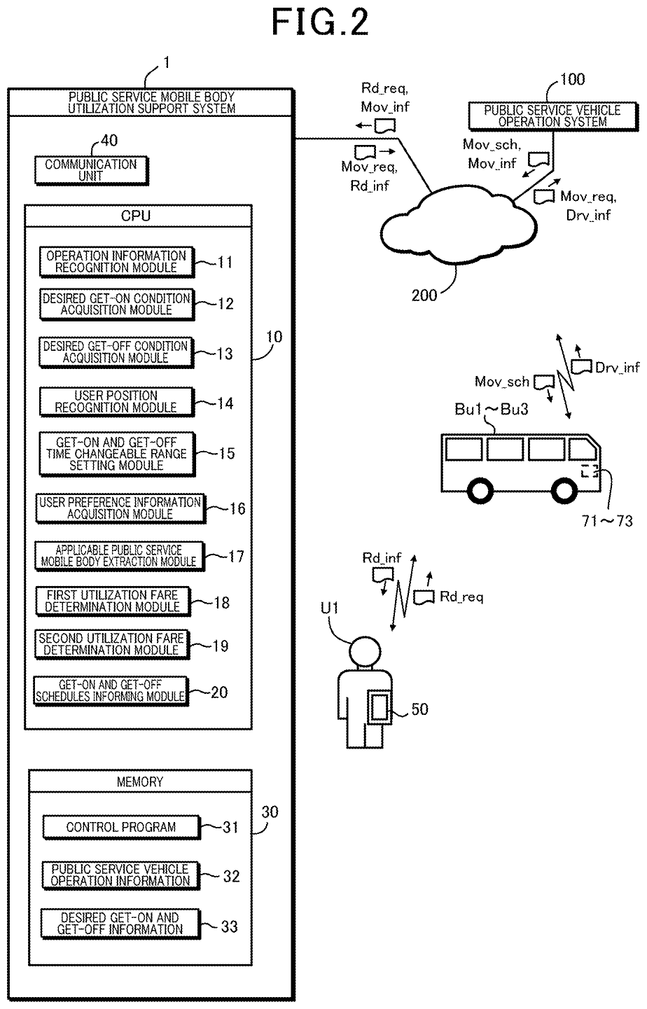

Referring to FIGS. 2 to 4, the configuration of the public service mobile body utilization support system 1 will be described. In FIG. 2, a case will be described in which the user U1 is supported in utilizing the public service vehicle. Referring to FIG. 2, the public service mobile body utilization support system 1 is a computer system made up of a central processing unit (CPU) 10, a memory 30, a communication unit 40, and the like. The public service mobile body utilization support system 1 communicates with the public service vehicle operation system 100 and the communication terminal 50 carried by the user U1 via a communication network 500 by the communication unit 40.

The onboard devices 71 to 73 mounted on the public service vehicles Bu1 to Bu3, respectively, communicate with the public service vehicle operation system 100 via the communication network 500. Then, as described above, the onboard devices 71 to 73 transmit running information Drv_inf including the current positions of public service vehicles Bu1 to Bu3 to the public service vehicle operation system 100. The public service vehicle operation system 100 transmits an operation schedule Mov_sch including determined operation routes and scheduled operation times to the onboard devices 71 to 73.

The communication terminal 50 of the user U1 transmits a desired get-on and get-off condition Rd_req to the public service mobile body utilization support system 1 according to an operation by the user U1. Then, the communication terminal 50 receives applicable public service vehicle information Rd_inf indicating information of an applicable public service vehicle extracted according to the desired get-on and get-off condition Rd_req from the public service mobile body utilization support system 1.

The public service mobile body utilization support system 1 transmits an operation information request Mov_req requesting operation information on the public service vehicles Bu1 to Bu3 to the public service vehicle operation system 100. Then, the public service mobile body utilization support system 1 receives operation information Mov_inf that is transmitted from the public service vehicle operation system 100 in response to receipt of the operation information request Mov_req.

The memory 30 of the public service mobile body utilization support system 1 stores a control program 31 for the public service mobile body utilization support system 1, public service vehicle operation information 32, and desired get-on and get-off information 33.

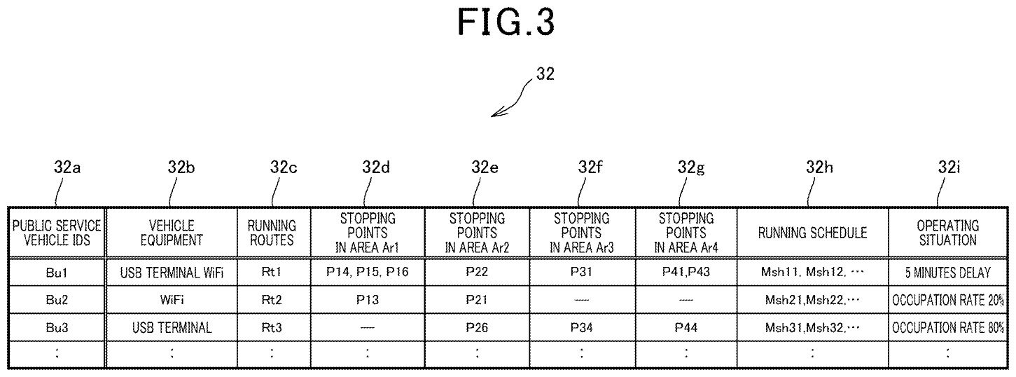

As shown in FIG. 3, the public service vehicle operation information 32 records therein, for each public service vehicle, public service vehicle identifications (IDs) denoted by reference numeral 32a, onboard vehicle equipment denoted by reference numeral 32b, running routes denoted by reference numeral 32c, bus stops where the public service vehicles stop in the area Ar1 denoted by reference numeral 32d, bus stops where the public service vehicles stop in the area Ar2 denoted by reference numeral 32e, bus stops where the public service vehicles stop in the area Ar3 denoted by reference numeral 32f, bus stops where the public service vehicles stop in the area Ar4 denoted by reference numeral 32g, running schedules denoted by reference numeral 32h, and operating situations denoted by reference numeral 32i. The public service vehicle operation information 32 illustrated in FIG. 3 records pieces of information for the public service vehicles Bu1 to Bu3 illustrated in FIG. 1.

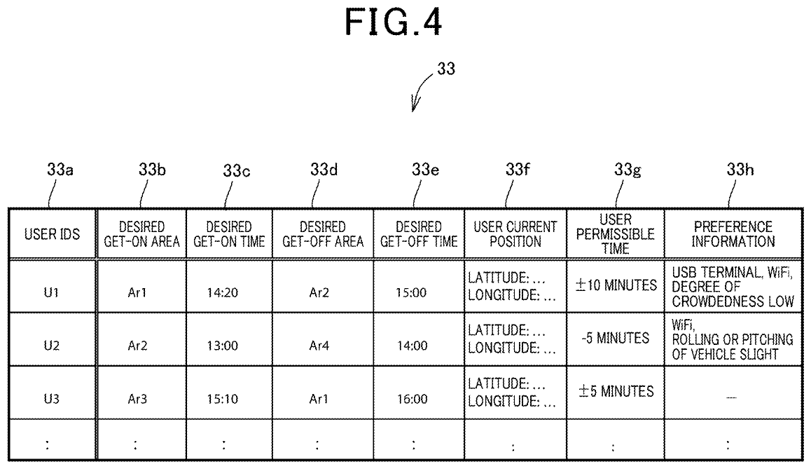

As illustrated in FIG. 4, the desired get-on and get-off information 33 records therein user IDs denoted by reference numeral 33a, desired get-on areas denoted by reference numeral 33b, desired get-on times denoted by reference numeral 33c, desired get-off areas denoted by reference numeral 33d, desired get-off times denoted by reference numeral 33e, users current positions denoted by reference numeral 33f, users permissible periods of time denoted by reference numeral 33g, and preference information denoted by reference numeral 33h.

Here, the users permissible periods of time represent changeable ranges of desired get-on times and desired get-off times that the users permit. The preference information is information indicating preferred riding environments that the users prefer and including available equipment (a USB terminal, a wireless communication environment through WiFi™, and the like) in the public service vehicles, riding comfort during traveling, crowdedness and the like.

The CPU 10 reads and executes the control program 31 to thereby function as an operation information recognition module 11, a desired get-on condition acquisition module 12, a desired get-off condition acquisition module 13, a user position recognition module 14, a get-on and get-off time changeable range setting module 15, a user preference information acquisition module 16, an applicable public service mobile body extraction module 17, a first utilization fare determination module 18, a second utilization fare determination module 19, and a get-on and get-off schedules informing module 20.

A processing executed by the operation information recognition module 11 corresponds to an operation information recognizing step in a public service mobile body utilization support method of the invention, and a processing executed by the desired get-on condition acquisition module 12 corresponds to a desired get-on condition acquiring step. Additionally, a processing executed by the desired get-off condition acquisition module 13 corresponds to a desired get-off condition acquiring step in the public service mobile body utilization support method of the present invention, and a processing executed by the applicable public service mobile body extraction module 17 corresponds to an applicable public service mobile body extracting step.

The operation information recognition module 11 transmits an operation information request Mov_req requesting the public service vehicle operation system 100 to transmit the operation information on the public service vehicles Bu1 to Bu3 to the public service vehicle operation system 100. Then, the operation information recognition module 11 receives operation information Mov_inf that is transmitted from the public service vehicle operation system 100 in response to the operation information request Mov_req received and records information recognized from the operation information Mov_inf in the public service vehicle operation information 32.

The desired get-on condition acquisition module 12 acquires a desired get-on condition including a desired get-on area and a desired get-on time from the desired get-on and get-off condition Rd_req transmitted from the communication terminal 50 of the user U1 and records it in the desired get-on and get-off information 33. The desired get-off condition acquisition module 13 acquires a desired get-off condition including a desired get-off area and a desired get-off time from the desired get-on and get-off condition Rd_req and records it in the desired get-on and get-off information 33.

The user position recognition module 14 recognizes a current position of the user U1 by receiving current position information transmitted from the communication terminal 50 of the user U1 and records it in the desired get-on and get-off information 33. The get-on and get-off time changeable range setting module 15 recognizes changeable ranges of a desired get-on time and a desired get-off time that the user U1 permits according to the desired get-on and get-off condition and records then in the desired get-on and get-off information 33.

The user preference information acquisition module 16 recognizes a public service vehicle utilization environment desired by the user U1 that is included in the desired get-on and get-off condition and records it in the desired get-on and get-off information 33. The applicable public service mobile body extraction module 17 extracts an applicable public service vehicle based on the desired get-on condition acquired by the desired get-on condition acquisition module 12, the desired get-off condition acquired by the desired get-off condition acquisition module, the current position of the user U1 recognized by the user position recognition module 14, the permissible time widths of the desired get-on time and the desired get-off time that are set by the get-on and get-off time changeable range setting module 15, and the preference information of the user U1 acquired by the user preference information acquisition module 16, the extracted applicable public service vehicle being fitted to the recognitions or acquired conditions.

The first utilization fare determination module 18 determines a public service vehicle utilization fare based on the get-on point where the user U1 gets on the public service vehicle according to a distance between the user U1 and the get-on point. For example, referring to FIG. 1, in the case where the applicable public service mobile body extraction module 17 extracts the public service vehicles Bu1 and Bu2 as applicable public service vehicles for traveling from the area Ar1 to the area Ar2, a get-on point for the public service vehicle Bu2 becomes P13. A get-on point for the public service vehicle Bu1 that lies nearest from the current position P0 of the user U1 becomes P16.

In this case, since a distance L2 between P0 and P13 is shorter than a distance L1 between P0 and P16, it is more convenient for the user U1 to get on the public service vehicle Bu2 by moving to P13 than to get on the public service vehicle Bu1 by moving to P16. However, for example, in the event that there is no scheduled user on the public service vehicle Bu2, it is effective in terms of cost to cancel the operation of the public service vehicle Bu2. Then, as this occurs, the first utilization fare determination module 18 sets the utilization fare of the public service vehicle Bu1 less expensive than that of the public service vehicle Bu2 so as to encourage the user U1 to utilize the public service vehicle Bu1.

In the case where the extraction of an applicable public service vehicle becomes possible due to a change in scheduled running route, the second utilization fare determination module 19 determines a utilization fare of an applicable public service vehicle according to an extent of the change. For example, in the example illustrated in FIG. 1, in the current operating situation of the public service vehicle Bu1, although the user U1 cannot get on the public service vehicle Bu1 at a desired get-on time desired by the user U1, the second utilization fare determination module 19 makes an inquiry about a possibility that a running route Rt1 is changed in such a way as to pass P13 as indicated by Rt11 so that the get-on point approaches the current position of the user U1 for the public service vehicle operation system.

When receiving a reply to the inquiry from the public service vehicle operation system 100 informing that the running route of the public service vehicle Bu1 can be changed, the second utilization fare determination module 19 determines a utilization fare according to the degree of the change in running route. As a result, when the operating situation is good enough to accept such a request for change, the request from the user U1 can be fulfilled, while an increased fare can be collected. As the degree of a change, an increment in running distance, an increment in running time, and the like can be used.

The get-on and get-off schedules informing module 20 informs the communication terminal 50 of the user U1 of the information on the applicable public service vehicle extracted by the applicable public service mobile body extraction module 17 and the utilization fare therefor. The applicable public service vehicle information includes a get-on point and a scheduled get-on time on the applicable public service vehicle and a get-off point and a scheduled get-off time from the applicable public service vehicle.

The communication terminal 50 of the user U1 displays the information on the applicable public service vehicle and the utilization fare, and by confirming the display on the communication terminal 50, the user U1 can move from the area Ar1 to the area Ar2 on the applicable public service vehicle that matches his or her preference while utilizing the space in the applicable public service vehicle. For example, the user U1 can work on the communication terminal 50 by utilizing the wireless communication environment via WiFi while charging the communication terminal 50 with a USB terminal inside the applicable public service vehicle.

### [3. Processing by Public Service Mobile Body Utilization Support System]

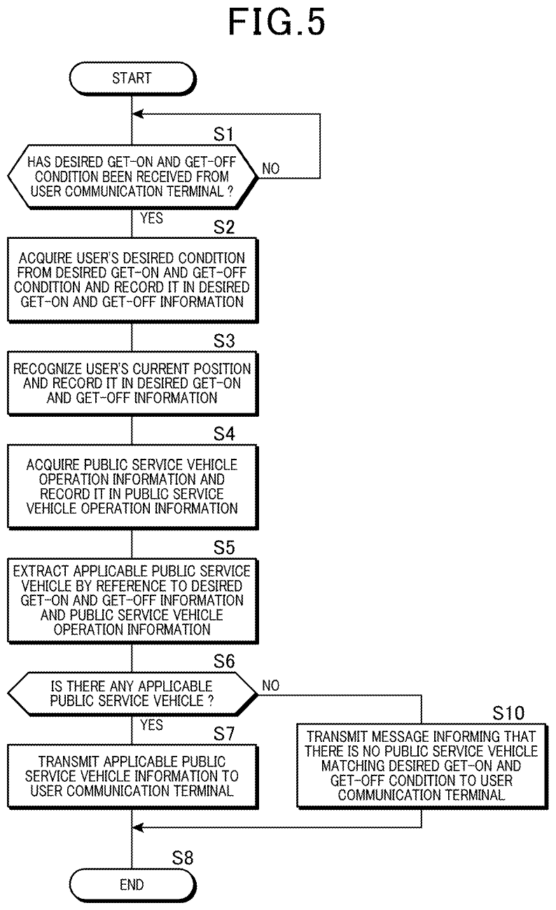

A public service vehicle utilization support process executed by the public service mobile body utilization support system for a user will be described according to a flow chart illustrated in FIG. 5. In the following description, a process will be described which will be executed in a case where in the situation illustrated in FIG. 1, the user U1 desires to move from the area Ar1 to the area Ar2 and makes a request for information on an available applicable public service vehicle.

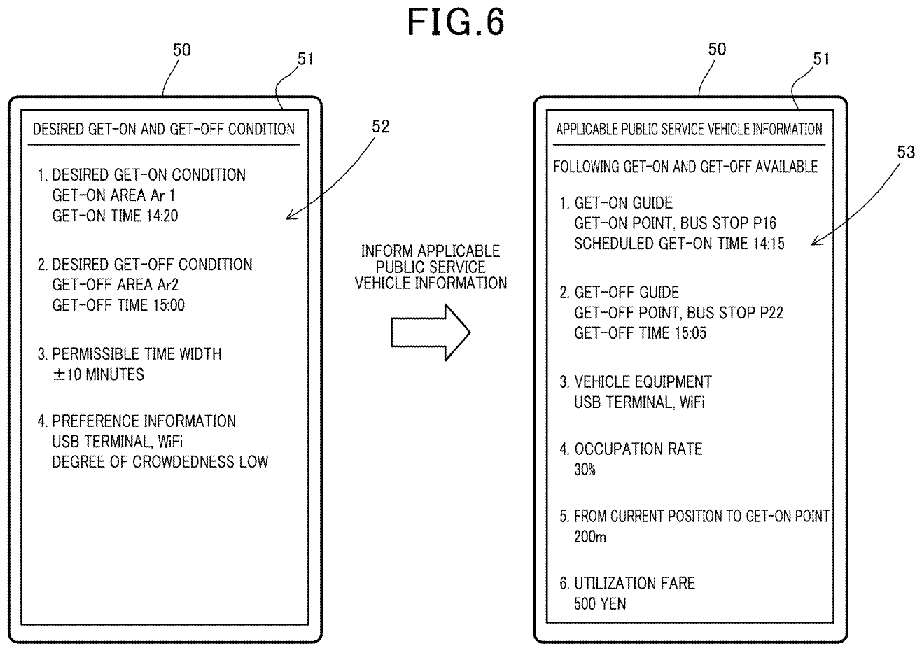

In FIG. 5, in step S1, when receiving a desired get-on and get-off condition Rd_req (refer to FIG. 2) from the communication terminal 50 of the user U1, the public service mobile body utilization support system 1 proceeds with a process in step S2. Here, as illustrated in FIG. 6, a desired get-on and get-off condition receiving screen 52 is displayed on a touch panel 51 provided on the communication terminal 50 of the user U1.

On the desired get-on and get-off condition receiving screen 52 illustrated in FIG. 6, as a desired get-on condition, the area Ar1 is designated as a get-on area, and 14:20 is designated as a get-on time. As a desired get-off condition, the area Ar2 is designated as a get-off area, and 15:00 is designated as a get-off time. Additionally, ±10 minutes is designated as a permissible time width for the get-on time and the get-off time. Further, as preference information, a USB terminal and WiFi are designated as onboard equipment, and the degree of crowdedness is designated as low.

In step S2, the desired get-on condition acquisition module 12 acquires a desired get-on area (here, Ar1) and a desired get-on time (here, 14:20) of the user U1 based on the desired get-on and get-off condition and records them in the desired get-on and get-off information 33. The desired get-off condition acquisition module 13 acquires a desired get-off area (here, Ar2) and a desired get-off time (here, 15:00) of the user U1 and records them in the desired get-on and get-off information 33. The get-on and get-off time changeable range setting module 15 sets a permissible time width (here, ±10 minutes) and records it in the desired get-on and get-off information 33. The user preference information acquisition module 16 acquires the preference information (here, the utilization of the USB terminal and WiFi, the low degree of crowdedness) from the desired get-on and get-off condition and records it in the desired get-on and get-off information 33.

Next, in step S3, the user position recognition module 14 recognizes the current position of the user U1 from the current position information received from the communication terminal 50 of the user U1 and recodes it in the desired get-on and get-off information 33. Following this, in step S4, the operation information recognition module 11 transmits the operation information request Mov_req (refer to FIG. 2) to the public service vehicle operation system 100, acquires the operation information Mov_inf, and records it in the public service vehicle operation information 32.

Next, in step S5, the applicable public service mobile body extraction module 17 executes an extraction of an applicable public service vehicle by reference to the desired get-on and get-off condition and the current position of the user U1 that are recorded in the desired get-on and get-off information 33 through the processes in steps S2 to S4 and the operation information on the public service vehicles Bu1 to Bu3 recorded in the public service vehicle operation information 32, the applicable public service vehicle matching the desired get-on and get-off condition of the user U1 and having a get-on position lying a predetermined distance (for example, 500 m) away from the current position of the user U1.

Then, the applicable public service mobile body extraction module 17 proceeds from the next step S6 to step S7 for processing when it can extract such an applicable public service vehicle, whereas when it cannot extract the applicable public service vehicle, the applicable public service mobile body extraction module 17 proceeds from step S6 to S10 for processing.

The get-on and get-off schedules informing module 20 transmits in step S7 applicable public service vehicle information Rd_inf (refer to FIG. 2) indicating information on the applicable public service vehicle to the communication terminal 50 of the user U1. The communication terminal 50 receives the applicable public service vehicle information Rd_inf and displays an applicable public service vehicle guide screen 53 indicating information on the applicable public service vehicle on the touch panel 51, as illustrated in FIG. 6.

On the applicable public service vehicle guide screen 53, a get-on point (here, a bus stop P11) and a scheduled get-on time (here, 14:15) are displayed as get-on information, and a get-off point (here, a bus stop P31) and a scheduled get-off time (here, 15:05) are displayed as get-off information. Further, on the applicable public service vehicle guide screen 53, the equipment (here, the USB terminal, WiFi) of the applicable public service vehicle, the current occupation rate (here, 30%) of the applicable public service vehicle, the distance from the current position of the user U1 to the get-on point (here, 200 m), and the utilization fare (here, 500 yen) are displayed. As has been described above, the utilization fare is determined by the first utilization fare determination module 18 or the second utilization fare determination module 19.

The user U1 confirms the applicable public service vehicle guide screen 53 and moves to the get-on point by the scheduled get-on time, whereby the user U1 can get on the applicable public service vehicle to arrive at the get-off point while making effective use of the space on the applicable public service vehicle.

The get-on and get-off schedules informing module 20 transmits in step S10 information informing that there is no applicable public service vehicle that matches the desired get-on and get-off condition of the user U1 to the communication terminal 50 of the user U1. When receiving the information, the communication terminal 50 displays a screen informing that there is no applicable public service vehicle on the touch panel 51. When confirming this display, the user U1 can take such an action as revising the desired get-on and get-off condition and sending again a request for extracting an applicable public service vehicle based on the revised condition to the public service mobile body utilization support system 1.

### [4. Other Embodiments]

In the embodiment described above, although the public service vehicles Bu1 to Bu3 such as buses are described as being public service mobile bodies, the present invention can also be applied to various types of public service mobile bodies such as public service taxies, trams, water buses, and the like.

In the embodiment described above, although the running routes Rt1 to Rt3 for the public service vehicles Bu1 to Bu3 are determined to pass through the preset areas, the running routes Rt1 to Rt3 may be determined to pass through the areas that are determined according to the demands of the users. Additionally, a configuration may be adopted in which while the public service vehicle is running along to the determined running route, the running route of the public service vehicle may be changed at all times according to the demands of other users (other users who are now riding in the vehicle or other who are going to get on the vehicle) without departing from the desired condition (the get-off area and desired get-off time) of the users who are now riding in the vehicle.

For example, referring to FIG. 1, in the case where the user U1 gets on the public service vehicle Bu1 in the area Ar1 and gets off the public service vehicle Bu1 after two hours, in the event that there is no other user who desires to get on or get off in the other areas, the running route for the public service vehicle Bu1 need only be determined to circulate within the area Ar1. In addition, when another user U2 desires to get on in the area Ar2 while the user U1 is riding in the public service vehicle Bu1, the running route of the public service vehicle Bu1 need only be changed so as to pass through the area Ar2. Further, in the case where another user U2 gets on the public service vehicle Bu1 in the area Ar1 and gets off after two hours in the area Ar2 after the user U1 has got on the public service vehicle Bu1, the running route of the public service vehicle Bu1 need only be changed to a running route in which firstly, the public service vehicle Bu1 drops the user U1 in the area Ar1 while the public service vehicle Bu1 is kept circulating in the area Ar1, and thereafter, the public service vehicle Bu1 moves to the area Ar2 to drop the user U2 there.

In the embodiment described above, the existing bus stops P11 to P17, P21 to P26, P31 to P34, and P41 to P44 are described as functioning as points in place for the public service vehicles Bu1 to Bu3 to stop to allow the users to get on and get off the public service vehicles Bu1 to Bu3. However, as another embodiment, the points in place for the public service vehicles to stop may be set to any points in place that match demands from the users.

In the embodiment described above, the public service mobile body utilization support system 1 is described as being made up of the computer system that communicates with the communication terminal 50 of the user U1. As another configuration, the whole or part of the public service mobile body utilization support system 1 may be made up of the communication terminal 50. In the case where the whole or part of the public service mobile body utilization support system 1 is made up of the communication terminal 50 of the user U1, the communication terminal 50 recognizes directly the get-on and get-off condition of the public service vehicle that is inputted by the user U1. Additionally, the communication terminal 50 communicates with the public service vehicle operation system 100 to acquire the operation information of the public service mobile body.

In the embodiment described above, the applicable public service mobile body extraction module 17 extracts the applicable public service vehicle (corresponding to an applicable public service mobile body in the present invention) that the user U1 can get on within the predetermined distance from the current position of the user U1 that the user position recognition module 14 recognizes. As another configuration, such an applicable public service vehicle may be extracted not based on the distance from the current position of the user U1 with the user position recognition module 14 omitted.

In the embodiment described above, the user preference information acquisition module 16 is provided, and the applicable public service mobile body extraction module 17 extracts the applicable public service vehicle that matches the preference of the user U1. As another configuration, such an applicable public service vehicle may be extracted not based on the preference of the user U1 with the user preference information acquisition module 16 omitted.

In the embodiment described above, the get-on and get-off time changeable range setting module 15 is provided, the get-on and get-off time changeable range setting module 15 sets the changeable time range for the get-on and get-off times according to the designation by the user U1. However, the changeable time range may be set at a fixed value (for example, ±10 minutes) in advance.

In the embodiment described above, the first utilization fare determination module 18 and the second utilization fare determination module 19 are provided. However, a configuration may be adopted in which only either of the first utilization fare determination module 18 and the second utilization fare determination module 19 may be provided. Alternatively, the utilization fare may be a fixed fare with the first utilization fare determination module 18 and the second utilization fare determination module 19 omitted.

It should be noted that FIG. 2 is a schematic diagram illustrating the functional configuration of the public service mobile body utilization support system 1 as being divided based on the main processing contents to facilitate the understanding of the invention of the present patent application, and hence, the configuration of the public service mobile body utilization support system 1 may be divided according to another basis. The processing of each constituent element may be executed by one hardware unit or may be executed by a plurality of hardware units. The processing of each constituent element illustrated in FIG. 5 may be executed by one program or may be executed by a plurality of programs.

### REFERENCE SIGNS LIST

1: public service mobile body utilization support system
10: CPU
11: operation information recognition module
12: desired get-on condition acquisition module
13: desired get-off condition acquisition module
14: user position recognition module
15: get-on and get-off time changeable range setting module
16: user preference information acquisition module
17: applicable public service mobile body extraction module
18: first utilization fare determination module
19: second utilization fare determination module
20: get-on and get-off schedules informing module
30: memory
31: control program
32: public service vehicle operation information
33: desired get-on and get-off information
50: communication terminal of user
60: small mobility
61: controller of small mobility
71 to 73: onboard device
100: public service vehicle operation system
200: traffic information server
500: communication network
U1 to U4: user
Bu1 to Bu3: public service vehicle (public service mobile body)
Ar1 to Ar4: area
Rt1 to Rt3: running route
P11 to P17, P21 to P26, P31 to P34, P41 to P44: bus stop (point in place where public service vehicle stops).

What is claimed is:

1. A public service mobile body utilization support system, comprising:
an operation information recognition module configured to recognize operation information of a public service mobile body;
a desired get-on condition acquisition module configured to acquire a desired get-on condition including a first area and a first time at which a user desires to get on the public service mobile body;
a desired get-off condition acquisition module configured to acquire a desired get-off condition including a second area and a second time at which the user desires to get off the public service mobile body; and
an applicable public service mobile body extraction module configured to extract an applicable public service mobile body based on the operation information, the desired get-on condition, and the desired get-off condition, the applicable public service mobile body being the public service mobile body that is scheduled to operate in such a manner as to allow the user to get on at the first time within the first area and to get off at the second time within the second area.

2. The public service mobile body utilization support system according to claim 1, comprising a get-on and get-off schedules informing module configured to inform the user of a get-on point and a scheduled get-on time at which the user gets on the applicable public service mobile body within the first area and a get-off point and a scheduled get-off time at which the user gets off the applicable public service mobile body within the second area.

3. The public service mobile body utilization support system according to claim 1, comprising:
a user position recognition module configured to recognize a current position of the user,
wherein the applicable public service mobile body extraction module extracts the applicable public service mobile body with which a distance between a get-on point within the first area and a current position of the user falls within a predetermined distance.

4. The public service mobile body utilization support system according to claim 1, comprising a first utilization fare determination module configured to determine a utilization fare of the applicable public service mobile body by the user according to a get-on point within the first area.

5. The public service mobile body utilization support system according to claim 4, wherein the first utilization fare determination module determines a utilization fare of the applicable public service mobile body by the user according to a distance between a get-on point within the first area and a current position of the user.

6. The public service mobile body utilization support system according to claim 1, comprising a second utilization fare determination module configured to, when the applicable public service mobile body is enabled to be extracted by the applicable public service mobile body extraction module by changing a scheduled running route of the public service mobile body, determine a utilization fare of the applicable public service mobile body by the user according to a degree of change of the scheduled running route.

7. The public service mobile body utilization support system according to claim 1, comprising:
a get-on and get-off time changeable range setting module configured to set a changeable range of the first time or the second time that the user can permit,
wherein the applicable public service mobile body extraction module extracts the applicable public service mobile body enabling the user to get on within the changeable range for the first time or to get off within the changeable range for the second time.

8. The public service mobile body utilization support system according to claim 1, comprising:
a user preference information acquisition module configured to acquire preference information of the user,
wherein the applicable public service mobile body extraction module extracts the applicable public service mobile body based on a preference of the user that the applicable public service mobile body extraction module recognizes from the preference information.

9. A public service mobile body utilization support method, comprising:
an operation information recognizing step of recognizing operation information of a public service mobile body;
a desired get-on condition acquiring step of acquiring a desired get-on condition including a first area and a first time at which a user desires to get on the public service mobile body;
a desired get-off condition acquiring step of acquiring a desired get-off condition including a second area and a second time at which the user desires to get off the public service mobile body; and
an applicable public service mobile body extracting step of extracting an applicable public service mobile body based on the operation information, the desired get-on condition, and the desired get-off condition, the applicable public service mobile body being the public service mobile body that is scheduled to operate in such a manner as to allow the user to get on at the first time within the first area and to get off at the second time within the second area.
